(19) United States
(12) Patent Application Publication
(10) Pub. No.: US 2009/0043914 A1
(43) Pub. Date: Feb. 12, 2009

(54) BOARD GAME SYSTEM AND METHOD OF USE THEREOF

(76) Inventor: Adam Komblum, Bellmore, NY (US)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 12/186,167

(22) Filed: Aug. 5, 2008

Related U.S. Application Data
(60) Provisional application No. 60/954,356, filed on Aug. 7, 2007.
(60) Provisional application No. 60/954,718, filed on Aug. 8, 2007.
(60) Provisional application No. 60/973,767, filed on Sep. 20, 2007.
(60) Provisional application No. 60/974,219, filed on Sep. 21, 2007.
(60) Provisional application No. 61/025,799, filed on Feb. 3, 2008.
(60) Provisional application No. 61/027,883, filed on Feb. 12, 2008.

(51) Int. Cl. G06F 3/00

(52) U.S. Cl. 710/1

(57) ABSTRACT

The present invention relates to an apparatus adapted for use with one or more fantasy purchase board games, and a method of using the apparatus, to incorporate the principles of debt and debt management into play of the board games.

### CROSS-REFERENCE TO RELATED APPLICATIONS

This application claims priority to, and incorporates by reference herein, in their entirety, U.S. Provisional Patent Application Ser. No. 60/954356, filed Aug. 7, 2007, U.S. Provisional Patent Application Ser. No. 60/954718, filed Aug. 8, 2007, U.S. Provisional Patent Application Ser. No. 60/973767, filed on Sep. 20, 2007, U.S. Provisional Patent Application Ser. No. 60/974219, filed on Sep. 21, 2007, U.S. Provisional Patent Application Ser. No. 61/025799, filed on Feb. 3, 2008, and U.S. Provisional Patent Application Ser. No. 61/027883, filed on Feb. 12, 2008.

### BACKGROUND

1. Technical Field

The present invention relates generally to a system for use with one or more board games and a method of using the system. More particularly, the present invention relates to a system adapted for use with a variety of fantasy purchase board games, and a method of using the system, to incorporate the principles of debt and debt management into play of the board games.

2. Background of Related Art

Board games have consistently served as a means of entertainment and education for both children and adults for many years. Fantasy purchase board games, or board games in which one or more players can “purchase” properties, acquire assets, and/or make investments, are particularly popular.

The art is replete with examples of such games, one of the most famous being MONOPOLY, which is disclosed in U.S. Pat. No. 2,026,082 to C. B. Darrow. The MONOPOLY patent discloses a board game which includes a board having spaces that correspond to real estate properties that may be improved upon by the players throughout the course of the game. Each player experiences an influx and an outflow of wealth that is embodied in mock currency.

Many modern fantasy purchase board games reflect contemporary economics and societal concerns, incorporating concepts such as debt management. One example of such a game may be seen through reference to U.S. Pat. No. 6,962,336 to Glass. The Glass reference discloses a credit card management board game in which players are initially assigned a credit card balance that they seek to reduce during play through the acquisition and sale of assets.

Also known in the art are games and apparatus that are adaptable to existing board games. U.S. Pat. No. 4,585,233 to Wilson discloses a board game which is capable of being used in conjunction with known board games to provide expanded and more complex game play. In particular, Wilson discloses a board game for use with MONOPOLY. Another adaptation on MONOPOLY is disclosed in U.S. Pat. No. 5,810,359 to Wilkins et al., in which various additional rules, features, and attributes are incorporated during play.

There exists a need in the art, however, for an apparatus that may be used in conjunction with one or more board games to incorporate the concepts of debt and debt mechanisms, as described herein below.

### SUMMARY

In one aspect of the present disclosure, a system adapted for use with at least one board game is disclosed that includes a control unit having at least one input mechanism to receive input datum that includes information relating to play of the board game from at least one source, a processor for processing the input datum and generating output datum, and a memory module for storing at least a portion of the input datum. The processor is in communication with the at least one input mechanism thereby facilitating the processing of the input datum and the generation of the output datum.

The input datum is selected from the group consisting of a number of players, player location, software, information stored on a debt medium, a cash balance, an influx of cash, a debt account balance, a player's signature, an asset value, a liability value, player movement, a payment, an interest rate, overdraft account information, and a debt account balance limit.

In one embodiment, the system further includes at least one debt medium including a storage medium for retaining debt medium information. In this embodiment, the at least one input mechanism is configured to interface with the at least one debt medium such that the at least one input mechanism and the at least one debt medium are in bidirectional communication.

In another embodiment, the at least one input mechanism includes a first input mechanism having receipt structure that is configured to receive the at least one debt medium, and a second input mechanism.

The control unit is configured for communication with a display module such that the output datum generated by the processor may be displayed thereon. The system may further include at least one connective member that is configured to facilitate communication between the control unit and the display module.

In another aspect of the present disclosure, a system is disclosed that is adapted for use with a game having a board, wherein the system includes a control unit having a first input mechanism and at least a second input mechanism to receive input that includes information relating to play of the board game datum from at least one source, and a processor for processing the input datum and generating output datum. The processor is in communication with the first and second input mechanisms thereby facilitating the processing of the input datum and the generation of output datum by the processor.

In one embodiment, the second input mechanism includes first and second sensors that are adapted for communication therebetween, at least one of which engages the board during play of the game.

In another embodiment, the control unit further includes a memory module for storing at least a portion of the input datum.

In yet another embodiment, the system also includes at least one debt medium that may include a storage medium for retaining debt medium information. In this embodiment, the first input mechanism is configured to interface with the at least one debt medium such that the first input mechanism and the at least one debt medium are in bidirectional communication.

In still another embodiment, the control unit further includes a third input mechanism may include a third sensor.

It is contemplated that the control unit may be configured for communication with a display module such that the output datum generated by the processor may be displayed on the display module.

A method of incorporating debt into one or more board games is also disclosed which includes the steps of providing a system adapted for use with the board game, or games, and playing the game. The system provided includes at least one debt medium and a control unit having at least one input mechanism to receive input datum from at least one source, a processor for processing the input datum into output datum, and a memory module for storing at least a portion of the input datum. The processor is in communication with at least the at least one input mechanism thereby facilitating the processing of the input datum into output datum by the processor.

In one embodiment, the at least one input mechanism is configured to interface with the at least one debt medium such that the at least one input mechanism and the at least one debt medium are in bidirectional communication.

In another embodiment, the control unit is configured for communication with a display module such that the output datum generated by the processor may be displayed on the display module.

In yet another embodiment, the at least one input mechanism includes a first input mechanism and at least a second input mechanism to receive input datum from at least one source. The second input mechanism includes first and second sensors that are adapted for communication therebetween.

### BRIEF DESCRIPTION OF THE DRAWINGS

The accompanying drawings, which are incorporated in, and constitute a part of this specification, illustrate embodiments of the disclosure and, together with a general description of the disclosure given above and the detailed description of the embodiment(s) given below, serve to explain the principles of the disclosure, wherein:

FIG. 1 is a side front perspective view of a system adapted for use with an exemplary board game having a control unit in accordance with the principles of the present disclosure;

FIG. 2 is a schematic view of the a processor, an input mechanism and a memory module of the control unit of FIG. 1, depicting bidirectional communication of the processor with both the input mechanism and the memory module;

FIG. 3 is a front view of one embodiment of the memory module of the control unit depicted in FIG. 1;

FIG. 4 is a front view of a debt medium for use with the system of FIG. 1;

FIG. 5 is a front perspective view of one embodiment of the control unit of FIG. 1;

FIG. 6 is a front perspective view of another embodiment of the system of FIG. 1;

FIG. 7 is a front perspective view of the control unit for use with the system of FIG. 1 or 6;

FIG. 8 is a front view of one embodiment of the control unit for use with the system of FIG. 1 or 6, wherein the control unit is in communication with a display module; and

FIG. 9 is a front view of an alternate embodiment of the control unit of FIG. 8.

### DESCRIPTION OF VARIOUS EMBODIMENTS

Various embodiments of the presently disclosed apparatus will now be described in detail with reference to the foregoing figures wherein like reference numerals identify similar or identical elements.

In the figures, and in the description which follows, the term “board game” should be understood as encompassing any now known, or later devised, apparatus or medium through which fantasy transactions, i.e. the imaginary acquisition of assets and/or the imaginary assumption of liabilities, may be conducted. The term “board game” should be further understood to encompass both physical, tangible apparatus, as well as virtual apparatus that may be played and/or maintained in a virtual space, such as a CD-ROM or the internet. The term “player” should be understood as referring to any entity subject to the constraints of game play, including any artificial, computerized, or automated entities. In addition, the term “debt” shall be construed as referring to any asset that is owed from one entity to another. Finally, the term “debt medium” shall be interpreted as any medium which may be used, for example, to reflect, record, or create debt. Examples of such debt mediums include, but are not limited to credit cards, debt cards, money orders, and checks.

Referring now to the drawings, FIG. 1 illustrates a system 100 that is adapted for use with a board game 10. Board game 10 will be depicted herein as a known board game. However, in no way should the following disclosure be limited by this depiction. As discussed above, board game 10 may be any tangible or virtual apparatus or medium through which fantasy transactions may be conducted, and system 100 may be used in conjunction with any such apparatus to incorporate the concepts of debt and debt mechanisms, as discussed herein below.

Board game 10 includes a board 12 having at least one path 14 along which one or more players travel during play. Path 14 may be divided into individual spaces 16, locations, or areas which may correspond, for example, to real estate, property or a specific action, such as the acquisition of wealth, the involuntary assumption of a liability or directed movement to another location or space 16 on path 14. Board game 10 may also include one or more playing pieces 18 used represent one or more players during play, mock currency 20 that may be used to effectuate the aforementioned fantasy purchases, and a movement mechanism (not shown), such as dice or a numbered wheel. The inclusion of additional elements or features, such as an instructional booklet, a tray or structure for holding or organizing mock currency 20, or a support structure for board 12 is envisioned by the present disclosure, but such additional elements or features will be not discussed herein in the interests of brevity.

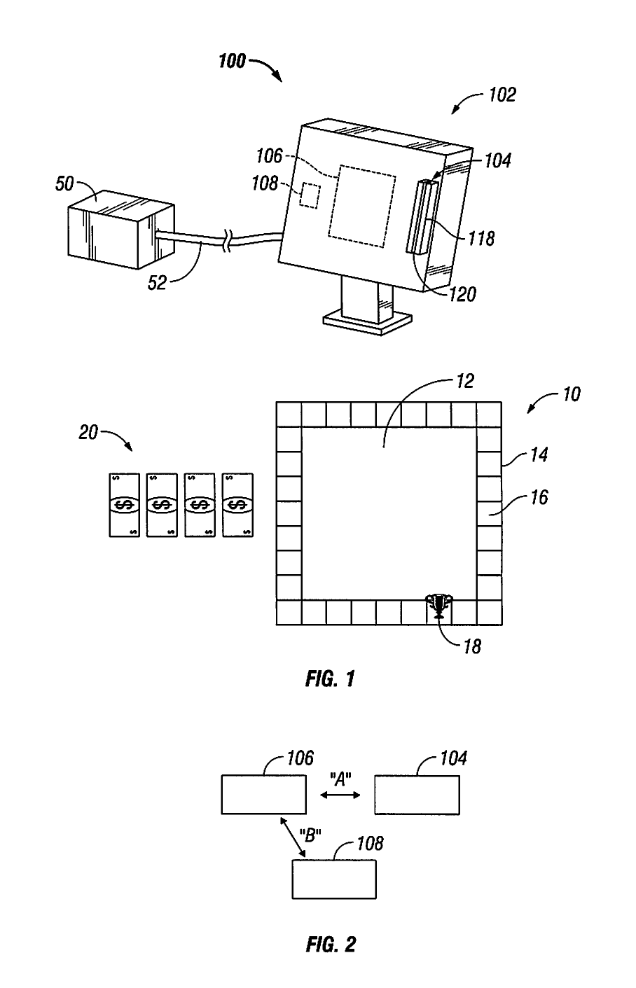

In one aspect of the present disclosure, system 100 is connected to a power source 50 and includes a control unit 102, an input mechanism 104, a processor 106, and a memory module 108. As seen in FIG. 2, processor 106 is in bidirectional communication with both input mechanism 104 and memory module 108, as indicated by arrows “A” and “B”, respectively. Control unit 102 receives information regarding game play in the form of input datum through the at least one input mechanism 104 and translates the input datum into a generated output, as discussed in further detail below.

Power source 50 provides the electrical energy required to operate system 100 and may be any source of power suitable for that intended purpose, e.g., a battery, AC current, DC current, etc. As depicted, power source 50 supplies power to system 100 through a feedline 52. The flow of power from power source 50 to system 100 may be interrupted through the use of a power switch (not shown), by disconnecting power source 50 from system 100, or in any other suitable manner.

Input mechanism 104 receives input datum from one or more sources (not shown), e.g. the player, or players, of the board game, as discussed in further detail below. As previously disclosed, input mechanism 104 is in bidirectional communication with processor 106 such that the input datum received thereby may be communicated to processor 106 for processing into output.

Processor 106 may be any mechanism suitable for the intended purpose of processing information, such as the input datum communicated thereto by input mechanism 104, and generating output. Processor 106 may be any structure, system or mechanism suitable for this intended purpose, including but not being limited to a central processing unit (CPU), computer or the like.

Memory module 108 is any medium suitable for the intended purpose of storing datum, including but not being limited to, a CD-ROM, a hard disk, or the like. Memory module 108 has a storage capacity sufficient to retain at least any datum that may be input during the course of operation of system 100, as described below, as well as any output datum generated by processor 106. It is contemplated that the storage capacity of memory module 108 may be sufficient to store the input and output datum indefinitely. It is also contemplated, however, that the input and output datum may be removed or deleted from memory module 108 upon the interruption of the flow of power to system 100. In one embodiment, memory module 108 may be pre-loaded with software that is executed by processor 106 during operation of system 100. As an example, this software may include one or more executable programs, e.g. a virtual embodiment of board game 10.

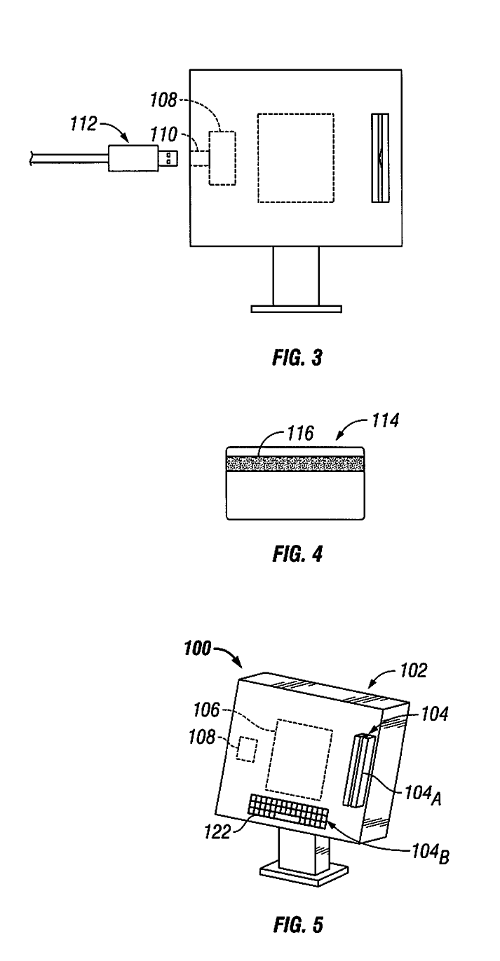

As seen in FIG. 3, in another embodiment, memory module 108 includes an input or upload port 110 that is configured to interface with an input device 112 such that additional or different software may be uploaded into memory module 108. Input device 112 may be any medium suitable for the intended purpose of storing or transferring datum, including, but not being limited to, a CD-ROM, a disk, or a universal serial bus (USB) cable.

In yet another embodiment, system 100 further includes at least one debt medium 114 (FIG. 4). Debt medium 114 includes at least one storage medium 116 and will generally take the physical form of a card, although other configurations are not beyond the scope of the present disclosure. Storage medium 116 retains information particular to the debt medium in which it is disposed, such as a player's debt account balance, discussed in further detail below. Storage medium 116 may take the form of a magnetic strip, an electronic chip, or the like, that may be disposed in any suitable location on or within storage medium 116.

Referring again to FIG. 1, input mechanism 104 of control unit 102 includes receipt structure 118, which facilitates the interface between input mechanism 104 and debt medium 114. Receipt structure 118 may be any structure suitable for the removable insertion of debt medium 114, such as a channel, a recess or the like. In one embodiment, as seen in FIG. 1, receipt structure 118 includes a channel 120 that is configured to slidably receive debt medium 114.

The interface between input mechanism 104 and debt medium 114 is such that bidirectional communication therebetween is established. This allows the information stored within storage medium 116 of debt medium 114 to be communicated to processor 106 by input mechanism 104, or alternatively, to memory module 108 for later processing by processor 106 into output. In addition, upon processing, the output datum generated by processor 106 may be communicated to debt medium 114 such that the information retained within storage medium 116 may be updated or changed. The information retained or stored within storage medium 116 and the output generated therefrom by processor 106 will be discussed in further detail below.

Referring now to FIG. 5, in an alternate embodiment of system 100, input mechanism 104 includes a first input mechanism 104_{A} and a second input mechanism 104_{B}. First input mechanism 104_{A} is configured to interface with debt medium 114 (FIG. 4) such that a first set of information or datum, retained by storage medium 116 (FIG. 4), may be communicated to either or both of memory module 108 and processor 106, as discussed above with respect to FIGS. 1 and 2. Second input mechanism 104_{B} receives a second set of information or datum that is input manually, for example, by one of the players. Second input mechanism 104_{B} may be any mechanism suitable for this intended purpose, including but not being limited to a keyboard 122. The second set of information may include the number of players, the location of each player on board 12 (FIG. 1), or any other information relevant or necessary for play. Upon its input into second input mechanism 104_{B}, the second set of information is communicated to processor 106 for processing into output, as discussed above with respect to the embodiment of FIGS. 1 and 2.

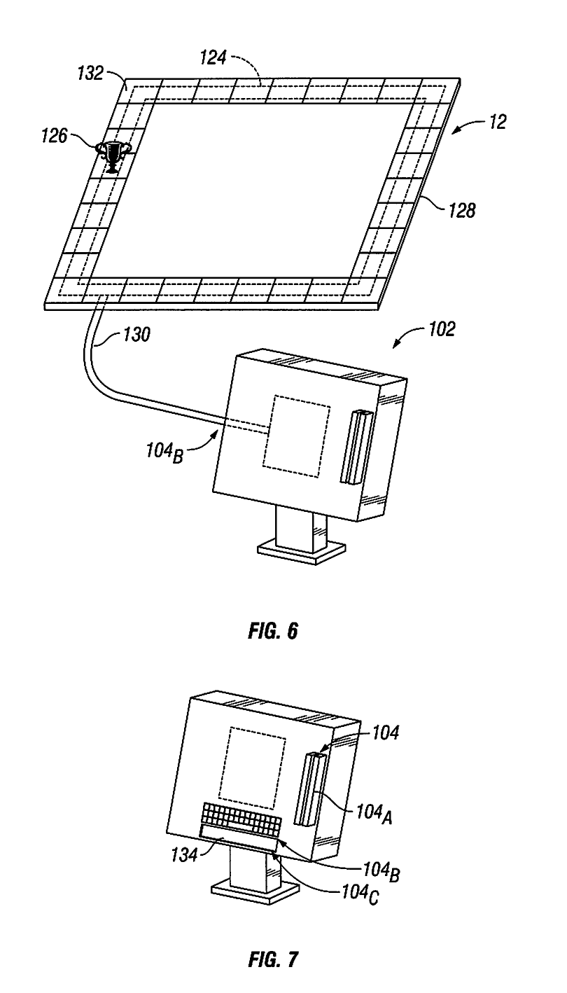

Referring to FIG. 6, in one embodiment, second input mechanism 104_{B} includes a first sensor 124 in communication with at least one second sensor 126. First sensor 124 is disposed beneath board 12 such that it engages a first side, or bottom 128 thereof. First sensor 124 is in communication, e.g. bidirectional communication, with control unit 102 through a connective member 130 such that information, or input datum, may be received from first sensor 124 of second input mechanism 104_{B} by processor 106 for processing into output, as discussed above with respect to the previous embodiments. Second sensor 126 may be disposed within a playing piece 18 (FIG. 1) particular to an individual player, or second sensor 126 may itself constitute the playing piece.

During play, second sensor 126 engages a second, or top side 132, of board 12. First sensor 124 receives a signal, transmission, information or the like from second sensor 126 regarding the position of first sensor 124 with respect to board 12. First sensor 124 receives this information from second sensor 126 in any suitable manner, including but not being limited to physical engagement therebetween, the use of RF current or magnetic fields. Upon the receipt of this information by first sensor 124, first sensor 124 communicates the information, or location of second sensor 126, to processor 106 through connective member 130 such that the information may be generated into output, as discussed above with respect to the previous embodiments.

It should be noted that the aforedescribed embodiment of FIG. 6 is only applicable with respect to those board games comprising a physical, tangible board.

Referring now to FIG. 7, in another embodiment, input mechanism 104 may further include a third input mechanism 104_{C}, in addition to first mechanism 104_{A} and any of the previously described embodiments of second input mechanism 104_{B}. Third input mechanism 104_{C} is in bidirectional communication with processor 106 such that information or datum received by third input mechanism 104_{C} may be processed and generated into output, as discussed above with respect to each of the previous embodiments. Third input mechanism 104_{C} includes a third sensor or pad 134 for receiving a player's mark or signature for the purpose of simulating a verification signature, as is customary upon the use of known debt media. The player's mark or signature is input into third input mechanism 104_{C} subsequent to the receipt of the first set of information upon the interface of debt medium 114 (FIG. 4) with first input mechanism 104_{A}, as discussed above with respect to the embodiments of FIGS. 1-5.

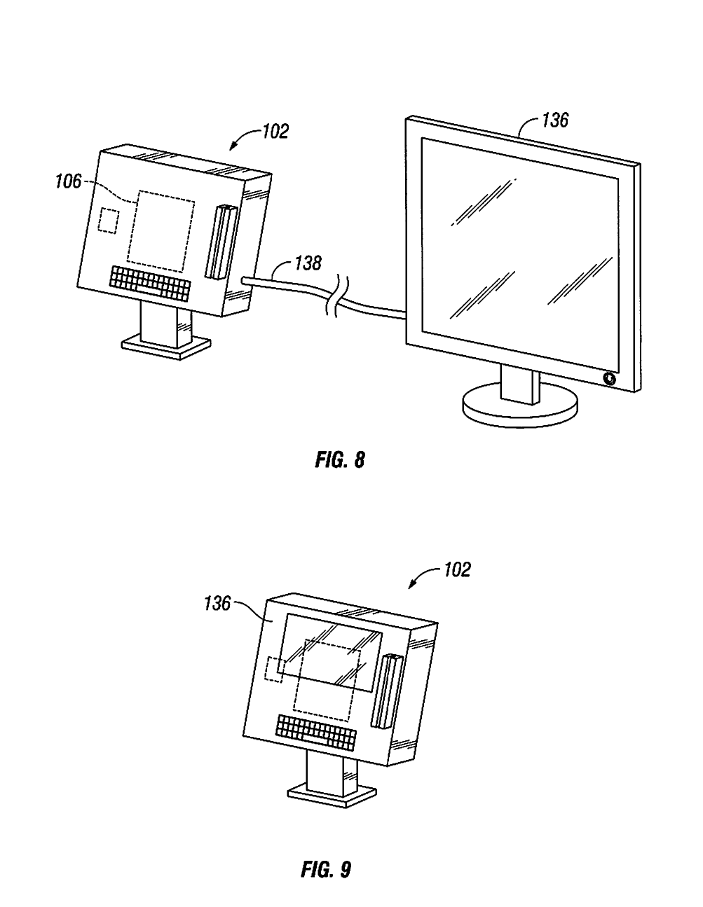

With reference to FIG. 8, control unit 102 is in communication with a display module 136 such that the output generated by processor 106 may be displayed thereon. Display module 136 may be any device suitable for the intended purpose of displaying an image, including but not being limited to a television, computer monitor, liquid crystal display (LCD) or the like. Control unit 102 may communicate with display module in any suitable manner, including but not being limited to the use of a cable member 138, although a wireless connection therebetween is also within the scope of the present disclosure. Cable member 138 may be any member suitable for the intended purpose of communicating information from control unit 102 to display module 136, including but not being limited to a coaxial cable or the like. As seen in FIG. 9, in one embodiment, display module 136 is integrally formed with control unit 102, thereby obviating the need for cable member 138.

With reference to FIGS. 1-9, the function of system 100 and a method of use thereof will be discussed. Initially, each player is given at least one debt medium 114, each player may choose a playing piece 18, and each player may be given a cash balance in the form of mock currency 20, if appropriate. Subsequently, upon each player's turn, each player advances along path 14. At each location or space 16, each player may choose, or may be required, to perform a particular task, e.g. to acquire an asset, to assume a liability, or to relocate to another position or space 16. The player then takes the appropriate action, at which time play is passed to the next player.

Prior to beginning play, control unit 102 displays a prompt on display module 136 requesting the number of players. The number of players is then input into control unit 102 using second input mechanism 104_{B}, and this input is then stored in memory module 108 throughout the game's duration. When used with a virtual embodiment of board game 10, i.e. in those embodiments in which the memory module 108 includes an executable program corresponding to the board game being played, the need to manually input the number of players prior to beginning play may be obviated, as this mechanism may be provided for in the software or programming stored within memory module 108 and executed by processor 106.

Upon each player's first turn, or at any other suitable time, each player interfaces the debt medium, or mediums, 114 given that player with first input mechanism 104_{A}. Initially, storage medium 116 of debt medium 114 is empty in that it retains no information particular to the player in possession thereof. However, upon interfacing debt medium 114 with first input mechanism 104_{A}, an association is created between each player and their particular debt medium, or media, 114 in the form of a debt account having a debt balance. Subsequently, each player may input an initial cash and/or debt account balance, if any, using second input mechanism 104_{B}. The cash balance and debt account balance information or input datum is then communicated to processor 106 for processing into output datum, such as a visual display of the account balances on display module 136, and/or to memory module 108 for storage or later processing by processor 106. Should an initial debt account balance be assigned to a player, that player will be required to interface the debt medium 114 particular to that player with first input mechanism 104_{A} such that the debt medium information may be updated, as described below. The initial cash and debt balances may be particular to each game, or they may be determined by the players prior to beginning play. The debt account information for each debt medium 114 includes datum regarding the debt account balance, payment amounts due, if any, and payment intervals, each discussed below, and is retained within each storage medium 116 of each debt medium 114.

Upon each subsequent interface with first input mechanism 104_{A}, the debt account information retained within storage medium 116 of debt medium 114 is communicated to processor 106 such that the debt account information may be updated, if necessary, as discussed below.

As each player traverses path 14, generally by a distance determined by a movement mechanism (not shown), the player's new location or the distance moved may be input into control unit 102 through second input mechanism 104_{B}. This input data is then communicated to processor 106 and/or memory module 108 such that control unit 102 may recognize, track, and update the location of each player during play. In the embodiment of system 100 seen in FIG. 6, control unit 102 automatically monitors each player's location through the communication between respective first and second sensors 124, 126 and control unit 102, as discussed above, thereby obviating the need for manual entry of this information.

During play, each player may acquire assets, including an influx of cash, and/or assume liabilities, including an outflow of cash or the assumption of debt. In so doing, each player may elect to use any mock cash or currency 20 within the player's possession, or the player may choose to incur a particular amount of debt. Should a player acquire an asset or assume a liability solely through the use of mock currency 20, that player's debt balance will remain unchanged as a result of the transaction. However, should a player elect to assume a level of debt in the acquisition of an asset or the assumption of a liability, that player's debt balance will be increased accordingly.

In those transactions involving only the use of mock currency 20, the player manually enters the number of currency units transferred into second input mechanism 104_{B}. This information is communicated to processor 106 and is processed into a new or updated cash balance reflecting the payment. This processed data is then output on display module 136 for viewing and is communicated to memory module 108 for storage such that the updated information may be accessed by processor 106 upon the execution of a subsequent transaction.

In those transactions combining a transfer of mock currency 20 units and an assumption of debt using debt medium 114, the player manually enters the number of cash units to be paid into second input mechanism 104_{B}. This information is then communicated to processor 106 and the player's cash balance is then adjusted. The updated cash balance information is then communicated to memory module 108 for updating, as discussed above. At this time, the player inserts debt medium 114 into first input mechanism 104_{A}, e.g. by swiping or drawing the debt medium 114 through channel 120, to complete the fantasy purchase. The information regarding the player's debt balance retained within storage medium 116 is then communicated from first input mechanism to processor 106. Processor 106 then updates, e.g. augments, the player's debt balance accordingly. This updated debt balance information is then communicated to and retained within storage medium 116 of debt medium 114, and displayed on display module 136 as output data for viewing by the player or players. In the embodiment seen in FIG. 7, prior to executing the debt transaction and updating the debt medium 114 information, control unit 102 may prompt the player for a signature or mark as a way to verify the purchase, at which time the player may “sign” third sensor 136 of third input mechanism 104_{C}. Third input mechanism 104_{C} then communicates the “signature” to processor 106 and processor 106 adjusts the player's account information in accordance with the transaction. Thereafter, the player's updated debt balance is communicated to storage medium 116 of debt medium 114 and may be displayed as output on display module 136 for viewing, as previously discussed.

In those transactions involving only debt purchases, the player need only insert debt medium 114 into first input mechanism 104_{A}. The player's debt balance information is then communicated to processor 106 for processing, and subsequently, the player's updated balance information is communicated to debt medium 114 for retention within storage medium 116 and displayed on display module 136, as previously discussed.

Any balance maintained within a debt account is subject to an interest rate that may be agreed upon by the players prior to beginning play, e.g. a compounding interest rate, that is particular to the debt medium 114 used to incur the debt, as discussed in further detail below. Accordingly, the debt balance will be increased until such time that the debt balance is paid in full.

Each player having a debt balance may be required to make a “payment” towards that balance at specified payment intervals, e.g. upon each complete traversal of path 14, in a particular amount. As an illustrative example, a player may be required to make a “minimum” payment of 10% of the debt balance at specified junctions of the game, e.g., after every five turns, after each traversal of the board, etc. Control unit 102 may alert such players at or before the time payment is due. Should a player have a currency balance that is less than the required debt payment, the game ends for that player and that player's playing piece 18 is retired. Alternatively, at the player's election, an overdraft account may be created which will make the required debt balance payment. The overdraft account information is maintained with memory module 108 and is communicated therefrom to processor 106 for display on display module 136. Payments may be made on a player's behalf from an overdraft account for a predetermined amount of time, e.g. one complete traversal of path 14, or until such time that the balance of the overdraft account reaches a predetermined level. At that time, the game would end for such a player and the player's playing piece would be retired.

In another aspect of play, each player may be given multiple debt mediums 114. Alternatively, each player may earn or become entitled to additional debt mediums 114 during play at the direction of a particular space 16 on path 14 or upon the occurrence of a predetermined condition, e.g. a cash balance that exceeds a predetermined amount or the acquisition of equity exceeding a specified value or particular assets. Each debt medium 114 attained by a player may have particular attributes or features, e.g. interest rates and limits. As an illustrative example, a player's first debt medium 114 may subject any debt balance to a first interest rate, e.g. 10%, and may require that player to make payments toward the debt balance at a first interval, e.g. upon each complete traversal of path 14, whereas a second debt medium 114 may subject any debt balance to a second interest rate, e.g. 5%, and may require that player to make payments toward the debt balance at a second interval, e.g. upon every other complete traversal of path 14.

While the above is a complete description of the embodiments of the present disclosure, various alternatives, modifications and equivalents may be used. Therefore, the above description should not be construed as limiting, but rather as illustrative of the principles of the disclosure made herein. Those skilled in the art will envision other modifications within the scope and spirit of the claims appended hereto.

What is claimed is:

1. A system adapted for use with at least one board game, comprising:
a control unit including at least one input mechanism to receive input datum from at least one source, the input datum including information relating to play of the board game;
a processor for processing the input datum and generating output datum; and
a memory module for storing at least a portion of the input datum, the processor being in communication with at least the at least one input mechanism thereby facilitating the processing of the input datum and the generation of output datum by the processor.

2. The system of claim 1, wherein the input datum is selected from the group consisting of a number of players, player location, software, information stored on a debt medium, a cash balance, an influx of cash, a debt account balance, a player's signature, an asset value, a liability value, player movement, a payment, an interest rate, overdraft account information, and a debt account balance limit.

3. The system of claim 1, further including at least one debt medium.

4. The system of claim 3, wherein the at least one input mechanism is configured to interface with the at least one debt medium such that the at least one input mechanism and the at least one debt medium are in bidirectional communication.

5. The system of claim 4, wherein the at least one debt medium includes a storage medium for retaining debt medium information.

6. The system of claim 3, wherein the at least one input mechanism includes a first input mechanism and a second input mechanism, the first input mechanism including receipt structure that is configured to receive the at least one debt medium.

7. The system of claim 1, wherein the control unit is configured for communication with a display module such that the output datum generated by the processor may be displayed on the display module.

8. A system adapted for use with a game having a board, comprising:
a control unit including a first input mechanism and at least a second input mechanism to receive input datum from at least one source, the input datum including information relating to play of the board game; and
a processor for processing the input datum and generating output datum, wherein the processor is in communication with the first and second input mechanisms thereby facilitating the processing of the input datum and the generation of output datum by the processor.

9. The system of claim 8, wherein the second input mechanism includes first and second sensors that are adapted for communication therebetween.

10. The system of claim 9, wherein at least one of the first and second sensors engages the board during play of the game.

11. The system of claim 9, wherein the control unit further includes a memory module for storing at least a portion of the input datum.

12. The system of claim 9, further including at least one debt medium.

13. The system of claim 12, wherein the first input mechanism is configured to interface with the at least one debt medium such that the first input mechanism and the at least one debt medium are in bidirectional communication.

14. The system of claim 13, wherein the at least one debt medium includes a storage medium for retaining debt medium information.

15. The system of claim 8, wherein the control unit further includes a third input mechanism.

16. The system of claim 8, wherein the control unit is configured for communication with a display module such that the output datum generated by the processor may be displayed on the display module.

17. A method of incorporating debt into at least one board game, comprising:
providing a system adapted for use with the at least one board game, the system including:
a control unit including at least one input mechanism to receive input datum from at least one source, a processor for processing the input datum into output datum, and a memory module for storing at least a portion of the input datum, wherein the processor is in communication with at least the at least one input mechanism thereby facilitating the processing of the input datum into output datum by the processor; and
at least one debt medium; and
playing the at least one board game.

18. The method of claim 17, wherein the step of providing a system adapted for use with the at least one board game includes providing a system wherein the at least one input mechanism is configured to interface with the at least one debt medium such that the at least one input mechanism and the at least one debt medium are in bidirectional communication.

19. The method of claim 18, wherein the step of providing a system adapted for use with the at least one board game includes providing a system wherein the control unit is configured for communication with a display module such that the output datum generated by the processor may be displayed on the display module.

20. The method of claim 19, wherein the step of providing a system adapted for use with the at least one board game includes providing a system wherein the at least one input mechanism includes a first input mechanism and at least a second input mechanism to receive input datum from at least one source, the second input mechanism including first and second sensors that are adapted for communication therebetween.
